(19) United States
(12) Patent Application Publication
(10) Pub. No.: US 2008/0294556 A1
(43) Pub. Date: Nov. 27, 2008

(54) MOBILE COMMERCE SERVICE

(76) Inventor: Jim Anderson, Cortlandt Manor, NY (US)

Correspondence Address: FISH & RICHARDSON P.C., P.O. BOX 1022, MINNEAPOLIS, MN, 55440-1022, US

(21) Appl. No.: 11/957,262

(22) Filed: Dec. 14, 2007

Related U.S. Application Data
(60) Provisional application No. 60/939,945, filed on May 24, 2007.
(60) Provisional application No. 60/948,054, filed on Jul. 5, 2007.

(51) Int. Cl. G06Q 20/00; H04Q 7/20

(52) U.S. Cl. 705/44; 455/466

(57) ABSTRACT

A payment system processes payments so that vendors and consumer may have an increased degree of confidence as to the security of the transaction. More precisely, a consumer enters a messaging address through which the user may receive communications on a wireless device using a vendor point of sale system. The consumer identifies goods for purchase and the vendor generates a transaction total for the identified goods. The consumer's messaging address is received and a transaction request is received at an intermediary server operated by a wireless carrier. The transaction request is presented to the consumer in a display on the wireless device. The consumer uses the wireless device to authorize the transaction request and transmits the authorization to the intermediary server. The intermediary server receives the authorization and transfers, based on receiving the authorization, resources to the vendor to pay the transaction amount.

### CROSS-REFERENCE TO RELATED APPLICATIONS

The application claims priority to U.S. Provisional Application No. 60/948,054, filed Jul. 5, 2007, entitled “A Mobile Commerce Service”, and U.S. Provisional Application No. 60/939,945, filed May, 24, 2007, entitled “A Messaging Service.”

### TECHNICAL FIELD

This document relates to messaging systems.

### BACKGROUND

A variety of appliances are being used to exchange messaging communications. For example, a user may use SMS (“Short Message Service”) or MMS (“Multimedia Messaging Service”) application to exchange communications. In one instance, friends may use a SMS application on a wireless phone to exchange SMS messages with friends. In another instance, a parent with a camera phone may send a photo of a child's baseball game to a grandparent using a MMS application.

### DESCRIPTION OF DRAWINGS

FIG. 1 illustrates a user interface receiving a MMS message from an intermediary system.

FIG. 2 illustrates a user interface (UI) of a report that includes one or more processing options.

FIG. 3 illustrates a UI of a message that is presented to the receiving user.

FIG. 4A illustrates a UI of an enhanced messaging service application.

FIG. 4B illustrates a UI of a report indicating that a message from a sender has been validated.

FIG. 4C illustrates UI a message has been delivered to the receiving user.

FIG. 5 illustrates a UI indicating that the message cannot be validated.

FIG. 6 is a block diagram of a communications system that includes wireless phones and an intermediary system configured to interface with a wireless network infrastructure.

FIG. 7 is a flow chart of a process by which messages are exchanged.

FIG. 8 is a flow chart of a process by which a customer makes payment to a taxi company using the customer's wireless phone.

FIG. 9 is a flow chart of a process by which a retailer can collect a credit card payment from a customer, using the customer's wireless phone, a credit card processing system, and a trusted intermediary system.

FIG. 10 is a flow chart of a process by which a selling user can collect a payment from a purchasing user, using the both users' wireless phones.

FIG. 11 is an illustration of an exemplary authorization message.

FIG. 12 is an illustration of an exemplary messaging-based wallet program customer enrollment form.

FIG. 13 is an illustration of an exemplary Message Wallet configuration interface.

FIG. 14 is an illustration of an exemplary contact preference interface.

FIG. 15 is an illustration of an exemplary third-party user configuration interface.

FIG. 16 is an illustration of an exemplary transaction authorization message interface.

FIG. 17 is an illustration of an exemplary wireless phone menu.

FIG. 18 is an illustration of an exemplary Message Wallet interface.

FIG. 19 is an illustration of an exemplary Receipts interface.

FIG. 20 is an illustration of an exemplary Inbox interface.

FIG. 21 is a flow chart of a process for handling transaction operations within the trusted intermediary system.

### DETAILED DESCRIPTION

Users increasingly rely on wireless phones to perform important tasks. In addition to relying on wireless phones to provide a voice communications capability, many wireless phones also offer a messaging capability. For example, a phone may include a SMS (“Short Message Service”) and/or MMS (“Multimedia Messaging Service”) application that enables messages to be exchanged using a wireless phone.

As messaging services continue to be adopted, developers are exploring a variety of applications that use wireless messaging functionality. For example, a developer may be interested in developing e-commerce applications that rely on messaging protocols to pay for goods and services and, in response, transfer funds. However, merchants and consumers may not want to participate in a messaging-based transaction system if they do not have confidence in the source of the messages. In another environment, a user may have concerns about exchanging messages dealing with sensitive subject matter.

As a result, an intermediary system may process messages so that a participating user may have an increased degree of confidence as to the origins and content of an electronic message. More precisely, messages may be processed by receiving, from a first user on a wireless phone, a first message addressed to a second user. An extended header that is related to the first user and is for the first message is accessed. Based on accessing the extended header, an alert is generated, the alert being configured to prompt the second user for processing instructions for the first message. A response to the alert from the second user is received. If the response includes an instruction from the second user to validate the message, a validation request is generated. The validation request is processed using a certificate authority. Based on a validation decision by the certificate authority for the validation request, a report for the second user with one or more processing options is generated. An instruction is received from the second user with a selection from among processing options. The first message is delivered to the second user if the instruction from the second user indicates that the message should be delivered.

For example, a first user on a wireless phone may send a MMS message addressed to a second user. An intermediary system intercepts the message for specialized processing. For example, a message processing agent in a wireless carrier may designate one or more messages for special processing on a special processing server. In particular, an extended header for the first message is accessed. The extended header may include information related to the sending user (e.g., the sending user's phone number or wireless handset identifier) and may be supplemented with additional information based on identification information related to the sending user.

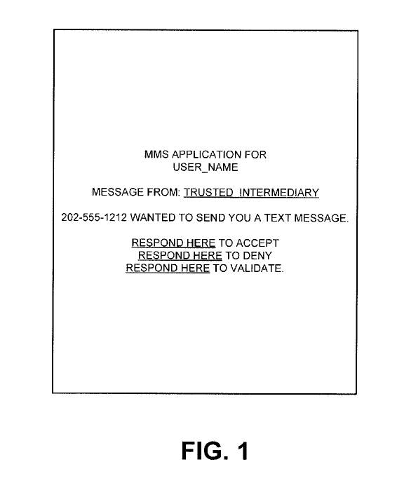

An alert is generated that is based on the extended header. For example, and as is shown in UI (“User Interface”) 100 in FIG. 1, the receiving user USER_NAME receives a MMS message from TRUSTED_INTERMEDIARY. TRUSTED_INTERMEDIARY represents an intermediary system that exchanges alerts and reports with a recipient user in order to determine whether the message should be delivered. UI 100 indicates that a user with handset identifier 202-555-1212 wants to send the second user a text message. The second user then has different options with which the recipient second user may respond. The second user can interact with one or more different hyperlinked options, for example, to accept, deny, or validate the text message. The recipient second user may respond to the alert by accepting the message, which will deliver the message to the second user without additional processing. The recipient second user also may deny the message to instruct the intermediary system to not deliver the message. The recipient user also may respond by instructing the intermediary system to validate the message.

Thus, in response to receiving the response to the alert from the second user, a validation request is generated. The validation request is processed using a certificate authority, for example, associated with the sending user and/or operated by a wireless carrier or other business entity (e.g., an online business certificate server).

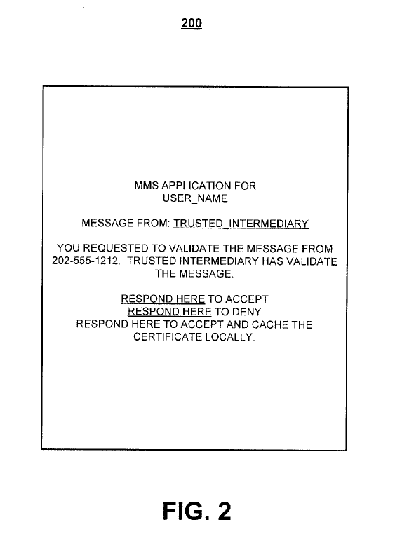

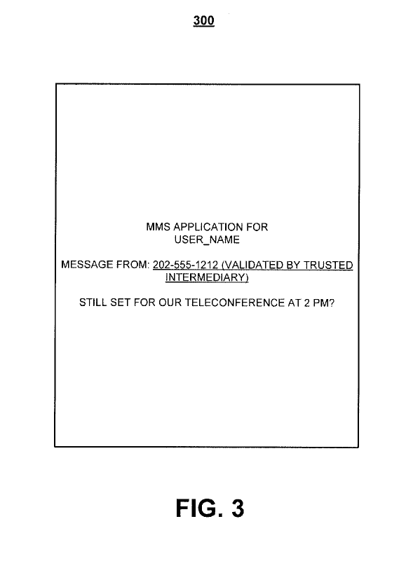

A report is generated that reflects the results of processing the validation request. FIG. 2 illustrates a UI 200 of a report that includes one or more processing options. UI 200 is sent by TRUSTED_INTERMEDIARY and indicates that the user has requested to validate the message from 202-555-1212. The report indicates that TRUSTED_INTERMEDIARY has validated the message. UI 200 then presents options to accept the message, deny the message, or to accept the message and cache the certificate locally. The second user then may select one of the options in order to instruct the trusted intermediary. If the second user has instructed the intermediary system to deliver the message, the intermediary system will deliver the message. In FIG. 3, UI 300 illustrates how the message may be presented to the second user. Specifically, UI 300 indicates that the message is from 202-555-1212, in contrast to the alert and report indicating origination from the TRUSTED_INTERMEDIARY (as was shown previously in UIs 100 and 200). UI 300 does indicate that the message has been validated by TRUSTED_INTERMEDIARY.

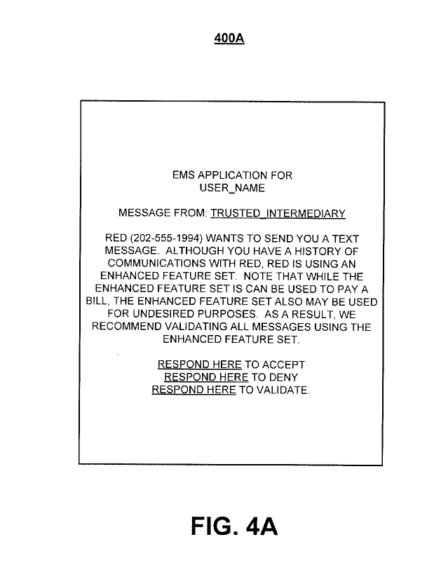

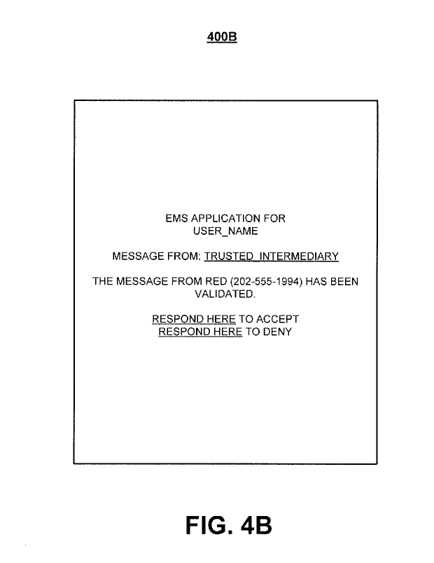

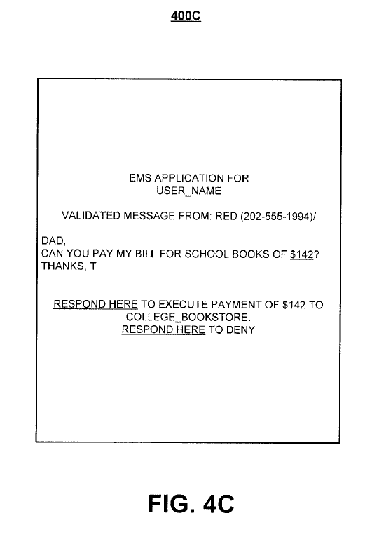

FIG. 4A illustrates a UI 400A of an enhanced messaging service application. UI 400 illustrates a message to USER_NAME from TRUSTED_INTERMEDIARY with an alert. In UI 400A, the TRUSTED INTERMEDIARY indicates that Red (a user identifier associated with phone number 202-555-1994) wants to send USER_NAME a message. UI 400A also indicates that despite a history of communications with Red, Red is sending USER_NAME a message with an enhanced feature set. UI 400A then communicates a warning relating to the enhanced feature set. UI400A indicates, “Note that while the enhanced feature set can be used to pay a bill, the enhanced feature set also may be used for undesired purposes. As a result, we recommend validating all messages using the enhanced feature set.” The recipient second user (USER_NAME) then is equipped to accept the message, deny the message, or validate the message. In FIG. 4B, UI 400B indicates that the message from Red has been validated. The second user is then prompted to accept or deny the message. In FIG. 4C, the message has been delivered and appears in UI 400C. In particular, Red appears to be asking his father to pay for a bill related to school books. The second user is then prompted to execute the payment of $142 or deny the charges.

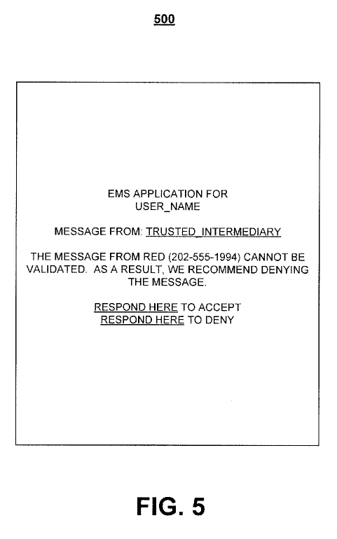

In contrast, and to illustrate a report where the message cannot be validated, FIG. 5 illustrates a GUI 500 indicating that the message from Red cannot be validated. The report in GUI 500 includes a recommendation to deny the message.

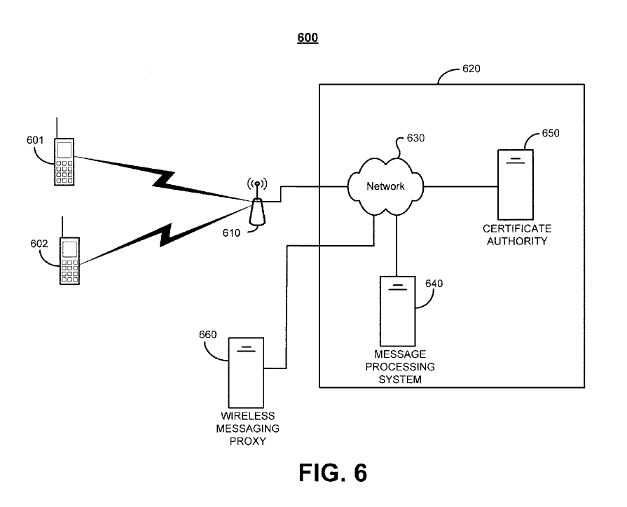

FIG. 6 is a block diagram of an exemplary communications system 600 where wireless phones 601 and 602 are configured to interface with a wireless infrastructure. Generally, wireless phones 601 and 602 display one or more UIs (e.g., the UIs described previously in FIGS. 1-5) to exchange messages using the wireless intermediary 620.

Each of the wireless phones 601 and 602 may include one or more devices capable of accessing a wireless network infrastructure 610 to exchange communications. The wireless phones may include one or more messaging applications.

In one implementation, the messaging application includes a messaging application that has been included by a manufacturer of a wireless phone. For example, a wireless manufacturer may develop a messaging application that works with other applications on the wireless phone (e.g., an address book application) in assisting users that are exchanging messages. The messaging application may include separately accessed modules for SMS and MMS applications. Alternatively, the messaging application may selectively invoke the appropriate messaging format (e.g., SMS vs. MMS) when format constraints call for a particular format to be used. For example, if the message is longer than 160 characters or includes an image, the messaging application may automatically format the message as a MMS message.

The messaging application also may include advanced modules that offer additional functionality beyond functionality required to exchange a SMS or MMS message. In one instance, the messaging application includes a certificate cache enabling a handset to perform its own certificate validation operations. For example, the message application may be configured to download automatically (or via user instruction) certificates for sending users with whom the receiving user has received communications. In particular, after a user has received a report indicating that a particular message has been validated, the user may be prompted to download the certificate for a particular user. The messaging application may be configured to then selectively download certificates in response to user instructions.

In another implementation, the messaging application may include modules that reduce the burden of responding to messages, alerts and reports. For example, the messaging application may be configured to determine that special terms appearing in a messaging application are “significant” in order to invoke advanced functionality. The messaging application may be configured to determine that the sending user's phone number represents a contact in an address book. As a result, the phone number may be replaced with the user's contact information from the address book. The receiving user then may select the contact information (e.g., name) to retrieve a list of one or more operations. The operations may include options to accept, deny or validate a message. The operations also may include enabling the receiving user to download the certificate for the user and perceiving a history of transactions with the sending user.

In yet another implementation, the messaging application links to other applications. For example, a messaging wallet application may be configured to use the validation functionality associated with the messaging application. In particular, the messaging wallet application may be configured to interface with an intermediary system in order to transfer funds from a user's line of credit to a merchant's accounts receivable. A consumer attempting to purchase goods or services from a merchant may provide an identifier (e.g., the consumer's phone number) using a retail point of sale system. The retail point of sale system may initiate a transaction sequence that results in a message being transmitted to the consumer's wireless phone. A messaging wallet application on the wireless handset then may be configured to interact with the intermediary system through a series of alerts, reports and responses exchanged using wireless messaging protocols.

In still another implementation, a validated message may be delivered in a secure manner, for example using a public key infrastructure (“PKI”). After validating the source of an incoming message from a first user, encryption keys may be exchanged between the first user transmitting handset, the certificate authority, and the second user receiving handset, consistent with a PKI encryption model. Alternatively, encryption keys can be exchanged as a separate message. Keys can also be included in the extended header information alerting the second user of the incoming SMS/MMS message. After keys have been exchanged between the first user handset, the certificate authority, and the second user handset, encrypted messages may be exchanged using the same accept-deny-validate protocol discussed above, or may be delivered directly.

Although SMS and MMS protocols were described in various implementations, other wireless messaging protocols may be used. For example, a wireless carrier may implement different wireless protocol that relies on a different wireless format and/or includes different wireless features.

In one implementation, the wireless phones 601 and 602 include one or more information retrieval software applications (e.g., a browser, a mail application, an instant messaging client, an Internet service provider client, a media player, or an integrated client) capable of receiving one or more data units. The information retrieval applications may run on a general-purpose operating system and a hardware platform that includes a general-purpose processor and specialized hardware for graphics, communications and/or other capabilities. In another implementation, the wireless phones 701 and 702 may include a wireless telephone running a micro-browser application on a reduced operating system with general purpose and specialized hardware capable of operating in mobile environments.

Each of the wireless phones 601 and 602 exchange communications with other devices using the wireless network infrastructure 610. The wireless network infrastructure may include, for example, a CDMA (“Code Division Multiple Access”) network or a TDMA (“Time Division Multiple Access”) network.

The wireless network infrastructure 610 includes systems and controllers that are configured to enable wireless phones (and other wireless messaging systems) to exchange communications. In one implementation, the wireless network infrastructure 610 includes the wireless towers, points-of-presence, switching centers, handoff controllers, billing systems, and other systems that provide a wireless phone with seamless connectivity to a wireless network.

The intermediary system 620 includes a communication infrastructure configured to facilitate the exchange of messages between users of the wireless network infrastructure 610, and also with peripheral systems (e.g., a merchant using wireless messaging proxy 660). The intermediary system 620 includes a network 630, a message processing system 640, and a certificate authority 650. In addition, the intermediary system 620 also is configured to exchange communications with the wireless messaging proxy 660.

The intermediary system 620 may be configured to receive messages from, for example, wireless phone 601 that are addressed to wireless phone 602. Within the intermediary system 620, the message processing system 640 is configured to process messages that have been received. The messaging proxy may designate one or more messages as enhanced messages that, in turn, involve exchange of alerts and reports between a recipient user and a sending user as to whether a message should be delivered to the sending user.

Each of the message processing system 640, certificate authority 650, and the wireless messaging proxy 650 may be implemented by, for example, a general-purpose computer capable of responding to and executing instructions in a defined manner, a personal computer, a special-purpose computer, a workstation, a server, a device, a component, other equipment or some combination thereof capable of responding to and executing instructions. These systems may be configured to receive instructions from, for example, a software application, a program, a piece of code, a device, a computer, a computer system, or a combination thereof, which independently or collectively direct operations, as described herein. The instructions may be embodied permanently or temporarily in any type of machine, component, equipment, or storage medium that is capable of being delivered to the message processing systems 640, certificate authority 650, and the wireless messaging proxy 650.

The intermediary system 620 may include and/or form part of an information delivery network, such as, for example, the Internet, the World Wide Web, an online service provider, and/or any other analog or digital wired and/or wireless network that provides information. Such information delivery networks may support a variety of online services, including Internet and/or web access, e-mail, instant messaging, paging, chat, interest groups, audio and/or video streaming, and/or directory services.

In one implementation, the intermediary system 620 includes one or more message exchanging applications for accessing and transmitting messages within the wireless network infrastructure 610. The message exchanging applications may run on a general-purpose operating system and a hardware platform that includes a general-purpose processor and/or specialized hardware. Another implementation may include a reduced operating system with both general purpose and specialized hardware to operate in mobile environments.

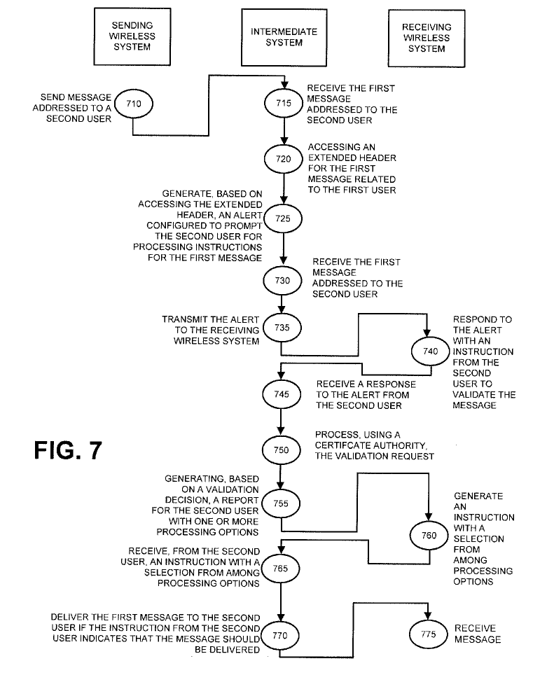

The message processing system 640 includes a system that processes messages originating from and sent to wireless phones 601 and 602 and other wireless devices in the wireless messaging system. The message processing system 640 may include a screening controller that selectively routes messages for additional processing. For example, the message processing system 640 may be configured to place messages from merchants requesting payment into a special queue. The messages in the special queue then may be processed using special procedure (e.g., the operations shown in FIG. 7) that increase the confidence of the intermediary and user that the transactions are valid. The message processing system 640 may selectively route messages based on the source address of the sender, the destination address of the recipient, and/or based on the contents of the message that indicate the message relates to processing a financial transaction.

The certificate authority 650 includes a system structured and arranged to host and validate digital certificates. The certificate authority 650 may be configured to enable users to access digital certificates for wireless subscribers and other nodes in the wireless network (e.g., merchants using a wireless messaging proxy). In one implementation, the digital certificate include the identity of a wireless subscriber (e.g., name and/or phone number), the public key for the individual being signed, a validity period, and the digital signature of the certificate produced by the certificate authority's private key.

In another implementation, the certificate server is configured to delegate to subordinate or different certificate authorities located external to the intermediary system 620. For example, the certificate authority 650 may be configured to delegate to a corporation's servers communications that involve the corporation's employees.

The network 630 includes hardware and/or software capable of enabling direct or indirect communications between the devices on the wireless network infrastructure 610 (e.g., wireless phones 601 and 602) and the devices within the intermediary system 620. As such, the network 420 may include a direct link between the wireless network infrastructure 610 and the intermediary system 620, or it may include one or more networks or sub networks between them (not shown). Each network or sub network may include, for example, a wired or wireless data pathway capable of carrying and receiving data. Examples of the delivery network include the Internet, the World Wide Web, a WAN (“Wide Area Network”), a LAN (“Local Area Network”), analog or digital wired and wireless telephone networks, radio, television, cable, satellite, and/or any other delivery mechanism for carrying data.

The wireless messaging proxy 660 includes a system that is configured to interface with a wireless messaging system using wireless messaging protocols. The wireless messaging proxy 660 may include a landline-based system that exchanges communications with the intermediary system 620 in order to communicate with wireless phones and/or other wireless messaging proxies. In one implementation, the wireless messaging proxy is configured to interface with a retail point-of presence located at a merchant.

FIG. 7 is a flow chart 700 of a process by which messages are exchanged. More precisely, flow chart 700 illustrates how an intermediary system exchanges alerts and reports with a user on a receiving wireless phone in order to determine whether the message should be delivered. Typically, the operations performed in flow chart 700 are performed on the systems described previously with respect to FIG. 6 and using the UIs described previously with respect to FIGS. 1-5. However, other systems and UIs may be used to exchange messages.

Initially, a first user on a sending wireless phone 701 sends a message addressed to a second user (710). For example, a first user may send a MMS message to a friend that is the second user on the receiving wireless phone 703. The MMS message may be addressed to the second user using the phone number on the second wireless phone. The intermediary system 702 receives, from the first user on the sending wireless phone 701, a first message addressed to a second user (715). For example, the intermediary system 702 may be configured to receive MMS messages from subscribers for a particular wireless carrier, charge the subscriber for the cost of the message, and transmit the MMS message to the recipient if the message is authorized (e.g., paid for and supported by message processing instructions).

The intermediary system 702 then accesses an extended header for the first message related to the first user (720). In one implementation, accessing the extended header includes identifying header information from a message that is received by the intermediary system. In another implementation, accessing the header includes referencing information related to the sender (as identified by device identification information from the received message).

The intermediary system 702 generates, based on accessing the extended header, an alert configured to prompt the second user for processing instructions for the first message (725). For example, the intermediary system 702 may generate an alert indicating that the sending wireless phone 701 associated with a particular telephone number wishes to send the message to receiving wireless phone 703. The intermediary system 702 may use call signaling information (e.g., the phone number of the sending system) and reference a database (or network-based address book for the receiving wireless phone 703) to provide additional information descriptive of the sending user (e.g., name and/or address information). In one implementation, the intermediary system 702 generates a label descriptive of past interactions with the user. For example, the intermediary system may include a “FAMILIAR” label in the subject of a MMS message for those users with which the user has exchanged at least a threshold number of messages or engaged in a threshold number of transactions.

The alert is then transmitted to the receiving wireless phone 703 (735). In one implementation, the alert is sent as a MMS message originating from the intermediary system 702. The alert may be formatted to simplify the burden on a user in responding, for example, by reducing the number of keys required by a user to respond to the alert. In one configuration, the alert may be formatted with hyperlinked fields that instruct intermediary system 702 how to respond. The hyperlinked fields may be generated by the intermediary system, or by a messaging application on the receiving wireless phone 703 that processes specified terms (e.g., “validate”) from specified senders (e.g., the receiving wireless phone 703) in a particular manner (e.g., by presenting the term “validate” as a selectable command).

The receiving wireless phone 703 then responds to the alert with an instruction from the second user to validate the message (740). For example, the user may respond to a message and type in the term, “validate.” Alternatively, the user may respond with an instruction to “deny” delivery or “deliver” a message. The intermediate system 702 then receives the response to the alert from the second user (745). In one implementation, the response includes a parameter descriptive of the instruction (e.g., a “1” to accept, a “2” to deny, a “3” to validate, a “4” to report message as suspicious, and a “5” for request help). The intermediary system 702 then may use the received parameter to instruct a messaging processing system in response. In another implementation, the intermediary system 702 is configured to analyze a message sent in response and determine if the response includes a term with special meaning (e.g., validate).

The intermediary system 702 generates, if the response includes an instruction from the second user to validate the message, a validation request (750). For example, the intermediary system 702 may encapsulate the message from the first user in a larger message and route the larger message to a certificate server for processing. The validation request is then processed using a certificate authority (755). Based on a validation decision by the certificate authority for the validation request, a report is generated for the second user with one or more processing options (760). In one implementation, the report includes an indication of whether the message has been validated, and options to deny or deliver the message. The receiving wireless phone 703 generates an instruction with a selection from among the processing options (760). More precisely, if the intermediary system 702 indicates that the message has been validated, the recipient user uses the receiving wireless phone 703 to indicate that the message should be delivered. The intermediary system 702 then receives, from the second user, an instruction with a selection from among the processing options (765). For example, the intermediary system 702 may receive a SMS message from the receiving wireless phone 703 indicating that the message should be delivered. The intermediary system 702 then delivers the first message to the second user if the instruction from the second user indicates that the message should be delivered (770). In one implementation, delivers the first message to the second user includes releasing a SMS message from a queue on a message processing system so that the SMS message may be delivered. The receiving wireless phone then receives the message (775).

Other implementations are within the scope of the following claims. For example, the operations need not be performed by wireless phones. A variety of other systems (e.g., messaging proxies) may be used to perform the operations described herein. For example, a merchant may operate a proxy messaging server that exchanges messages with customers, some of whom may be using wireless phones, using a wireless messaging protocol. Thus, the proxy messaging server may send messages to a customer's wireless phone in order to execute the transaction.

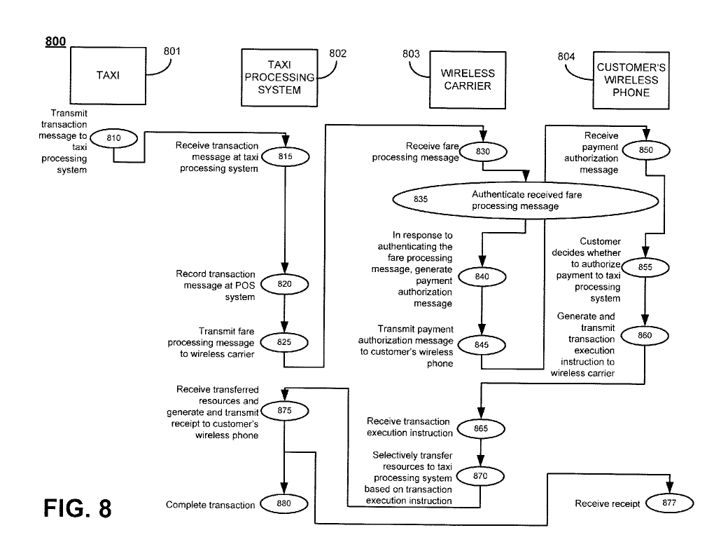

FIG. 8 is a flow chart 800 of a process by which a customer makes payment to a taxi company using the customer's wireless phone.

Initially, a taxi 801 transmits a transaction message to a taxi processing system 802 (810). The transaction message may include information such as, for example, a customer's wireless phone number and transaction amount. The transaction message may be generated by, for example, voice or keypad entry, and may be sent using various techniques, such as, for example, wireless device transmission. The taxi processing system 802 receives the transaction message (815) and records the transaction message at the Point of Sale (“POS”) system (820).

The taxi processing system 802 may include a plurality of components configured to process a taxi fare transaction. For instance, a dispatcher may receive a transaction message transmitted from a taxi. The dispatcher may be a human, a computer, or any device or system capable of receiving a transaction message from the taxi. For example, a taxi driver may use a dispatch radio installed in the taxi vehicle to notify a human dispatcher when a particular customer's trip starts. The information transmitted to the human dispatcher may include, for example, the origin and planned destination, the number of passengers, and the wireless phone number of the paying customer. Alternatively, the taxi driver may input the transaction information into a device (e.g., computer) having a keyboard or touch screen, whereby the device may transmit the information wirelessly to a taxi fare processing system, such as, for example, taxi processing system 802, which is capable of receiving the transmission.

After receiving the transaction message, the dispatcher may forward the transaction message to a POS system. The transaction message may not reach the POS system directly, but, rather, may travel through a gateway computer system or network, for example, prior to receipt at the POS system.

After the POS system receives the transaction message, the taxi processing system 802 transmits a fare processing message to wireless carrier 803 (825). The fare processing message may include details of the taxi service transaction, such as, for example, the customer's wireless phone number, a taxi number and driver, trip origin and destination information, date and time of service, length of trip, and total fare due. The fare processing message also may include information for the wireless carrier to use in authenticating the message.

Wireless carrier 803 receives a fare processing message (830). The wireless carrier 803 authenticates the received fare processing message by, for example, using information included within the fare processing message (835). Authentication, which also may be referred to as validation, may be performed using a certificate authority. If the certificate authority, for example, validates the fare processing message, the wireless carrier 803 generates a payment authorization message (840).

In addition to, or instead of, using a certificate authority, other techniques may be used to authenticate the received fare processing message. For example, authenticating the fare processing message may be implemented in the manner described above with reference to FIGS. 1-7. In some implementations, authenticating the fare processing message may involve only one party to the transaction. Additionally, or alternatively, two or more transacting parties may be involved in authenticating the fare processing message. For example, in a single-party mode, the wireless carrier authenticates a fare processing message by validating the fare processing message sent from the taxi company, while in a multiple-party mode, the wireless carrier validates the fare processing message from the taxi company and the customer validates the transaction message from the wireless carrier. In some implementations, performing authentication of the fare processing message may not involve any party to the transaction. For instance, a wireless carrier may maintain a list of trusted parties that do not require additional authentication. If both parties to a transaction are included in the wireless carrier's trusted party list, then neither party is necessary to authenticate the fare processing message.

In some implementations, the message may be authenticated when a payment authorization message is received by a customer's wireless phone 804 (not shown). In yet another implementation, the message may be authenticated at substantially the same time as the wireless carrier 803 is processing the fare processing message and after the user's wireless phone 804 has received a payment authorization.

The wireless carrier 803 transmits a payment authorization message to the customer's wireless phone (845). A payment authorization message may include details of the transaction, such as, for example, the taxi services rendered and details transmitted by the taxi processing system 802 in the fare processing message. The customer authorization message also may include options allowing the customer to indicate whether the transaction is authorized.

The customer's wireless phone 804 receives the payment authorization message (850) and the customer decides whether to authorize payment to the taxi processing system 802 (855). After deciding, the customer inputs the decision into the customer's wireless phone 804. The customer's wireless phone 804 generates and transmits a transaction execution instruction to the wireless carrier 803 (860).

The wireless carrier 803 receives the transaction execution instruction (865) and selectively transfers resources to the taxi processing system 802 based on the transaction execution instruction (870). Typically, the resources that are transferred may include some form of electronic credit; however, the transferred resources also may include other forms of value necessary to complete the customer's payment. The taxi processing system 802 receives the transferred resources and then generates and transmits a receipt to the customer's wireless phone 804 (875). The customer's wireless phone 804 receives the receipt (877). Substantially simultaneously, the taxi processing system 802 completes the transaction (880).

Although flow chart 800 shows a taxi fare processing system, other operations may be performed and other systems may be used. For example, a taxi company may elect to preauthorize a transaction to ensure that funds are available to pay for particular planned services. After the services are rendered, the taxi company may request payment from the customer, who then authorizes the payment. In some implementations, accounts used for payment may include more than one account that the customer is authorized to use. For example, a customer may use a personal account for taxi services while on vacation and use a business account for taxi services when traveling to a client meeting.

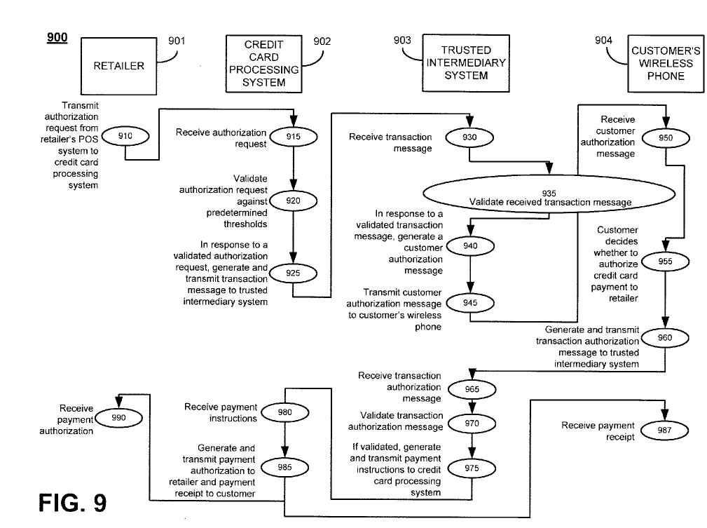

FIG. 9 is a flow chart 900 of a process by which a retailer 901 can collect a credit card payment from a customer, using the customer's wireless phone 904, a credit card processing system 902, and a trusted intermediary system 903. The credit card payment is validated against predetermined thresholds to prevent fraudulent transactions.

Initially, a customer purchases a product from a retailer 901 and the retailer 901 transmits an authorization request from the retailer's POS system to a credit card processing system 902 (910). The retailer's POS system may include a human, computer, or any device or system capable of recording and processing a retail transaction.

An authorization request includes details relevant to the customer's transaction with the retailer 901. The authorization request may include information such as the customer's name, billing address, credit card number, credit card expiration date, credit card security code (e.g., credit verification value or credit verification code), retailer's name, transaction amount, transaction date, transaction time, transaction location, items purchased, and wireless phone number.

After a retailer 901 transmits an authorization request (910), a credit card processing system 902 receives the authorization request (915). The credit card processing system 902 validates the authorization request against predetermined thresholds (920).

Predetermined thresholds are used to prevent fraudulent credit card transactions. The credit card processing system 902 uses information included within the authorization request to determine whether the customer's credit card transaction is allowed after comparing the transaction to predetermined thresholds associated with the customer's credit card account. Predetermined thresholds may be set by the credit card processing system 902 or the credit card holder. Examples of thresholds may include the customer's credit limit, limits on retailers (e.g., no purchase allowed at casinos), limits on purchases of certain items (e.g., no purchase of alcohol allowed), or geographic limits (e.g., no purchase allowed from retailers in foreign countries).

Once validated, a credit card processing system 902 generates and transmits a transaction message to a trusted intermediary system (925). The transaction message is received by the trusted intermediary system 903 (930). The trusted intermediary system 903 uses information included within the transaction message to authenticate the transaction message (935). Authenticating the transaction message may occur through use of a certificate authority. If the certificate authority authenticates the transaction message, the trusted intermediary system 903 generates a customer authorization message (940).

In addition to, or instead of, using a certificate authority, other techniques may be used to authenticate a received transaction message. For example, authenticating the transaction message may be implemented in the manner described above with reference to FIGS. 1-7. In some implementations, authenticating the transaction message may involve only one party to the transaction. Additionally or alternatively, two or more transacting parties may be involved in authenticating the transaction message. For example, in a single-party mode, the trusted intermediary system 903 authenticates the transaction message by validating the transaction message sent from the credit card processing system 902, while in a multiple-party mode, the trusted intermediary system 903 authenticates the transaction message from the credit card processing company 902 and the customer validates the customer authorization message sent from the trusted intermediary system 903 to the customer's wireless phone 904. In some implementations, authenticating the transaction message may not involve any party to the transaction. For instance, the trusted intermediary system 903 may maintain a list of trusted parties that do not require additional authentication. If both parties to a transaction are included in the trusted intermediary system's 903 trusted party list, then neither party is necessary to authenticate the message.

While authenticating the transaction message may be performed as a trusted intermediary system 903 receives the transaction message as shown, authentication also may be performed after a customer's wireless phone 904 receives a customer authorization message (not shown). In yet another implementation, authenticating the transaction message may occur at substantially the same time as the trusted intermediary system 903 is processing the transaction message and after the customer's wireless phone 904 receives a customer authorization message (950).

The trusted intermediary system 903 transmits the customer authorization message to the customer's wireless phone 904 (945). A customer authorization message may include details of the transaction. The details represent the retail transaction and may include details transmitted by the retailer 901 in the authorization request (910). The customer authorization message includes options that allow the customer to indicate whether the transaction is authorized.

The customer's wireless phone 904 receives the customer authorization message (950), and the customer decides whether to authorize payment to the retailer 901 by the credit card processing system 902 (955). After deciding, the customer inputs the decision into the customer's wireless phone 904. The customer's wireless phone 904 generates a transaction authorization message instruction and transmits the transaction authorization message to the trusted intermediary system 903 (960).

The trusted intermediary system 903 receives the transaction authorization message (965) and authorizes or validates the message to ensure its authenticity from the customer's wireless phone 904. Authorization or validation of the transaction authorization message (970) may occur in the same manner as earlier described (935). Though not shown, the trusted intermediary system 903 may rely on the prior authenticated or validated transaction message (935) and skip the additional message authentication or validation (970). After the transaction authorization message is authenticated or validated, the trusted intermediary system 903 generates and transmits payment instructions to the credit card processing system 902 (975).

Payment instructions are generated by the trusted intermediary system 903 (975) and represent the customer's response to the customer authorization message received at the customer's wireless phone 904 (955). Once the credit card processing system 902 receives the payment instructions (980), it generates and transmits a payment authorization to the retailer 901 and transmits a receipt to the customer's wireless phone 904 (985). A payment authorization electronically credits the retailer 901 with the value necessary to fulfill the customer's transaction obligation. The customer receives an electronic receipt at the customer's wireless phone 904 (987). The retailer 901 receives payment authorization from the credit card processing system 902 (990).

Although flow chart 900 shows a retail transaction processing system, other operations may be performed and other systems may be used. For example, a hotel company may use the system to preauthorize a transaction and ensure that sufficient credit is available to pay for a planned hotel stay reservation. After the hotel stay, the hotel company requests payment from the customer, who authorizes the payment. The accounts used for payment may include other accounts that the customer is authorized to use. The customer may use a personal credit account to purchase clothing at a retail store and use a corporate account for pay for hotel expenses while traveling on business.

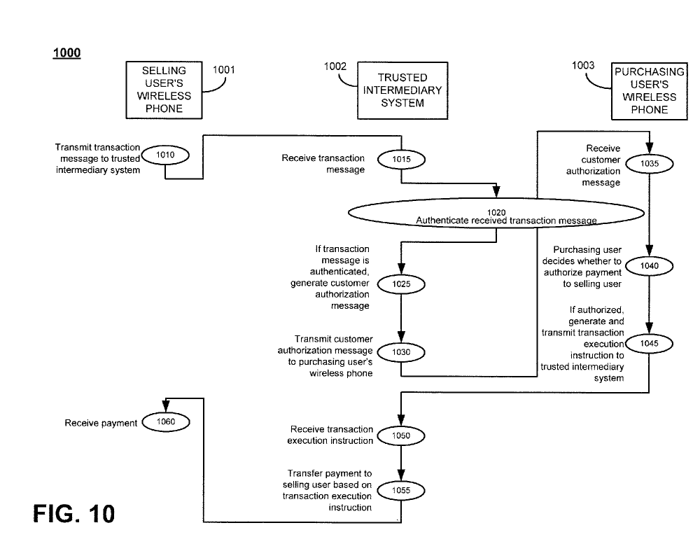

FIG. 10 is a flow chart 1000 of a process by which a selling user 1001 can collect a payment from a purchasing user 1003, using the both users' wireless phones. The payment is validated through a trusted intermediary system 1002.

Initially, the selling user's wireless phone 1001 transmits a transaction message to a trusted intermediary system 1002 (1010). A transaction message may include details of the transaction, such as the item purchased, date of sale, time of sale, total purchase price, selling user's wireless phone number and purchasing user's wireless phone number. The trusted intermediary system 1002 receives the transaction message (1015). The trusted intermediary system 1002 uses information included within the transaction message to authenticate the message (1020). Authentication may occur through use of a certificate authority. If the certificate authority verifies the transaction message, the trusted intermediary system 1002 generates a customer authorization message (1025).

In addition to, or instead of, using a certificate authority, other techniques may be used to verify the received transaction message. For example, authenticating the transaction message may be performed in the manner described above with reference to FIGS. 1-7. In some implementations, authenticating the transaction message may involve only one party in the transaction. Additionally or alternatively, two or more transacting parties may be involved in authenticating the transaction message. For example, in a single-party mode, the trusted intermediary system 1002 verifies the transaction message by validating the transaction message sent from the selling user's wireless phone 1001, while in a multiple-party mode, the trusted intermediary system 1002 verifies the message from the selling user's wireless phone 1001 and the purchasing user's wireless phone 1003 verifies the message from the trusted intermediary system 1002. In some implementations, authenticating the transaction message (1020) may not involve any party to the transaction. For instance, the wireless carrier may maintain a list of trusted parties that do not require additional authentication. If both parties to a transaction are included in the trusted intermediary system's 1002 trusted party list, then neither party is necessary to authenticate the transaction message.

While authenticating the transaction message may be performed as the trusted intermediary system 1002 receives the transaction message as shown, verification also be performed after the purchasing user's wireless phone 1003 receives a payment verification message (not shown). In yet another implementation, authenticating the transaction message may be performed at substantially the same time as the trusted intermediary system 1002 is processing the transaction message and after the purchasing user's wireless phone 1003 receives a customer authorization message (1035).

The trusted intermediary system 1002 transmits the customer authorization message to the purchasing user's wireless phone 1003 (1030). A customer authorization message may include details of the transaction. The details represent the transaction between the selling and purchasing users and may include details transmitted by the selling user in the transaction message (1010). The customer authorization message includes options allowing the purchasing user to indicate whether the transaction is authorized.

Once the purchasing user's wireless phone 1003 receives the customer authorization message (1035), the purchasing user then decides whether to authorize payment to the selling user (1040). After deciding, the purchasing user inputs the decision into the wireless phone. The wireless phone generates a transaction execution instruction and transmits the instruction to the trusted intermediary system 1002 (1045).

The trusted intermediary system 1002 receives the transaction execution instruction (1050). Payment is then transferred to the selling user based on the transaction execution instruction (1055). The selling user's wireless phone 1001 receives payment from the trusted intermediary system 1002 (1060). After the selling user's wireless phone 1001 receives payment, the transaction is complete.

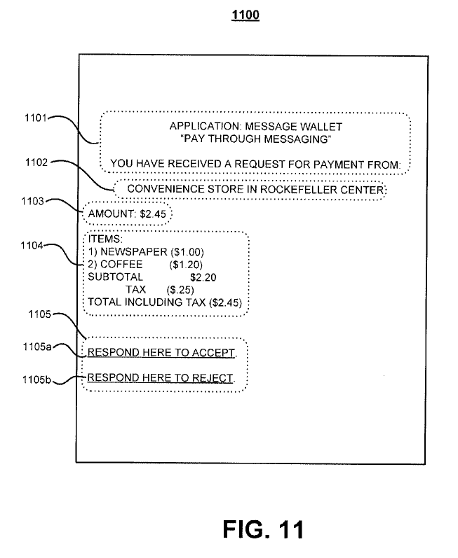

FIG. 11 is an illustration of an exemplary authorization message 1100. The authorization message 1100 may be provided to a customer by being sent to the customer's wireless phone as described above.

The authorization message 1100 includes several components: a title 1101, a retailer name 1102, an amount 1103, a purchase summary 1104, and response options 1105. The title 1101 alerts the customer to an action item from the customer's Message Wallet. More particularly, the title indicates that a request for payment from a retailer is available for review. The retailer name 1102 informs the customer of the retailer requesting a payment.

The amount 1103 summarizes a total purchase price of the transaction for which the retailer requests payment. The amount 1103 may be displayed in any currency. For example, if a citizen of the United States travels abroad to the United Kingdom, the retail transaction may occur in Pounds or Euros. The authorization message may be configured to convert the total purchase price of the transaction to the equivalent currency amount of the country in which the customer is a citizen. Thus, in the immediate example, the currency in which the customer made the transaction may be converted from Pounds or Euros to Dollars.

The purchase summary 1104 includes all items purchased in a particular transaction. Each item may be individually listed and may include pricing information, quantity purchased, and weight. Additionally, the purchase summary 1104, as shown, includes any taxes or fees added to the transaction. The purchase summary 1104 includes a subtotal and a final total, which is the total purchase price after adding fees and taxes.

Response options 1105 include options for the customer to accept or reject the retailer's authorization message. A user may accept the transaction by selecting the accept option 1105a or may reject the transaction by selecting the reject option 1105b. Once the customer selects an option, the customer's selection is transmitted to a payment processing system and payment is transferred from a bank account, credit card, or debit card that, for example, the customer previously associated with his Message Wallet based on the selected option. The customer may input a selection using a touch screen, stylus, scrolling wheel, button or any device that can accept a customer input.

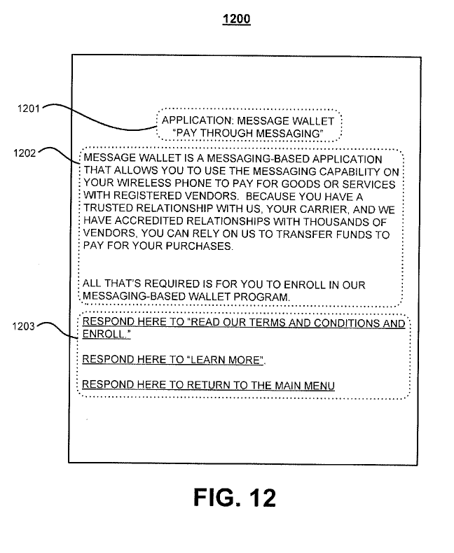

FIG. 12 is an illustration of an exemplary messaging-based wallet program customer enrollment form 1200. This message alerts the enrolling user to the general capabilities of the messaging-based wallet program and provides access to terms and conditions of the program. The enrollment form provides access to information allowing a user to learn more about the message wallet program.

The customer enrollment form 1200 includes several components: a title 1201, a detailed description message 1202, and response options 1203. The title 1201 may describe the application which generates the message, for example: Message Wallet. The title 1201 also may provide a description informing the user of the message's subject, for example: “Pay through messaging.”

The detailed description message 1202 includes a detailed description of the Message Wallet. The detailed description also may describe capabilities of the Message Wallet service and describe the relationship between the Message Wallet and retailers.

The response options 1203 include various options that the customer may select to learn more information about the Message Wallet service. For instance, the customer may select an option to read about the terms and conditions of Message Wallet, review Message Wallet capabilities, or return to the main menu. If the customer chooses any of the response options 1203, the customer retains the option to return to the enrollment form.

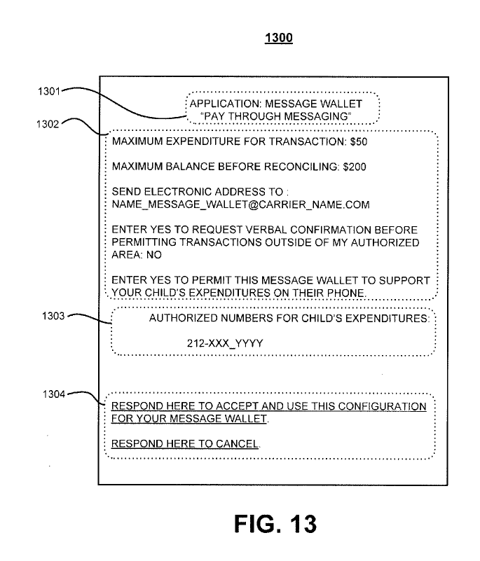

FIG. 13 is an illustration of an exemplary Message Wallet configuration interface 1300. The configuration interface allows the Message Wallet customer to set conditions on Message Wallet use. The Message Wallet configuration interface 1300 includes several components: a title 1301, configuration parameter 1302, authorized user configuration 1303, and response options 1304.

The title 1301 describes the application which generates the message, for example: Message Wallet. The title 1301 provides a description informing the user of the message's subject, for example: “Pay through messaging.”

The configuration parameter 1302 allows the Message Wallet customer to set parameters for Message Wallet use. For example, the customer may set a maximum expenditure per transaction amount. This amount limits the total value of any transaction paid using the Message Wallet. The customer also may set a maximum balance before reconciling amount, which determines the total value of transactions that occur before reconciling the Message Wallet account balance. The customer also may set an electronic address to which Message Wallet transaction confirmations and receipts are sent. The customer may set a verbal confirmation parameter, which determines whether verbal customer confirmation is necessary to complete a transaction. Additionally, the verbal confirmation parameter may be defined such that only transactions occurring outside of the customer's authorized area require verbal confirmation. The customer also may set parameters to allow additional users to process transactions through the customer's Message Wallet. More particularly, a parent may use the additional user parameter to allow a child to access the parent's Message Wallet to pay for the child's transactions. For example, a parent may configure their Message Wallet for child access such that the child could pay for their school lunch using the parent's Message Wallet.

The authorized user configuration 1303 allows the Message Wallet customer to input the wireless phone number of a user allowed to access the customer's Message Wallet to pay for transactions. For example, the Message Wallet customer may enter their child's wireless phone number, allowing the child to pay for transactions through the parent's Message Wallet. The child's transactions are paid through the parent's Message Wallet only after the parent receives a transaction notification and approves the purchase.

Response options 1304 allow the Message Wallet customer to choose whether to accept new changes and save the current configuration for future Message Wallet use. Alternatively, the customer may select the cancel option to cancel changes to the Message Wallet configuration.

Message Wallet configuration interface 1300 provides the Message Wallet customer the option to allow additional users to access the customer's Message Wallet. For example, a parent may allow a child to access the parent's Message Wallet. The parent may then monitor the child's spending and choose whether to authorize Message Wallet transactions initiated by the child. The Message Wallet configuration interface 1300 is not limited to familial relationships. For instance, a corporation may use the Message Wallet configuration interface 1300 to authorize its employees to use the corporation's Message Wallet to pay for business transactions. As described in the examples above, the Message Wallet configuration interface 1300 allows the Message Wallet customer to supervise transactions of linked users.

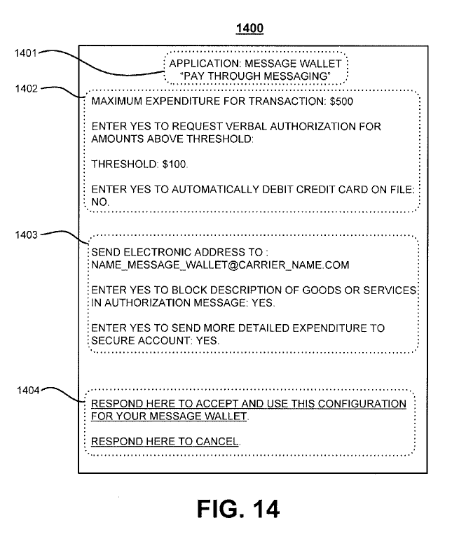

FIG. 14 is an illustration of an exemplary contact preference interface 1400 for configuring the customer's transaction contact preferences. The contact preference interface 1400 includes several components: a title 1401, payment options 1402, contact options 1403, and response options 1404.

The title 1401 is similar to titles 1201 and 1301, as described above.

Payment options 1402 provide the customer with options to set transaction thresholds. Thresholds may include limits on total transaction value, limits on authorized retailers, and geographic limits. Additional payment options 1402 may include a verbal authorization threshold requirement. For example, if a transaction requires payment above the transaction threshold, the customer must verbally authorize the Message Wallet transaction. Further, payment options 1402 may include an option to automatically bill the credit card, debit card, bank account or other payment source. Alternatively, the Message Wallet customer may choose to bypass automatic billing and select an alternative payment source.

Contact options 1403 allow the customer to change transaction notification options. The customer may change the e-mail address to which transaction authorization messages and notifications are sent. The customer also may choose whether to block the detailed description included with the transaction authorization messages. For example, if the detailed description is blocked, a purchase summary 1104 may include a total transaction amount, but may not include a detailed description of each item included in the transaction.

A customer may change the contact options 1403 to hide the details of a transaction from other authorized users of the same Message Wallet. For example, a customer may choose to hide the details of a Message Wallet transaction when purchasing a spouse's anniversary gift. By hiding transaction details and sending authorization messages to a different e-mail address, the contact options 1403 may allow a Message Wallet customer to keep private the details of a gift purchase.

Response options 1404 allow the Message Wallet customer to choose whether to accept new changes and save the current configuration for future Message Wallet use. Alternatively, the customer may select the cancel option to cancel changes to the Message Wallet configuration.

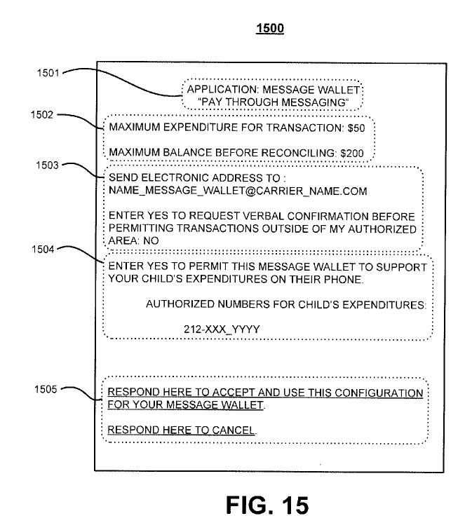

FIG. 15 is an illustration of an exemplary third-party user configuration interface 1500 that supports configuring the customer's Message Wallet for transactions from third-party users. The third-party configuration interface includes several components: a title 1501, transaction threshold options 1502, communication options 1503, third-party user options 1504, and response options 1505.

The title 1501 is similar to titles 1201 and 1301, as described above.

Transaction threshold options 1502 allow the Message Wallet customer to specify transaction thresholds. For example, the customer may set a maximum expenditure per transaction amount. This amount limits the total value of any transaction paid using the Message Wallet. The customer also may set a maximum balance before reconciling amount, which determines the total value of transactions that occur before reconciling the Message Wallet account balance.

Communication options 1503 allow the Message Wallet customer to specify communication preferences. The customer may set an electronic address to which Message Wallet transaction confirmations and receipts are sent. The customer also may set a verbal confirmation parameter, which determines whether verbal customer confirmation is necessary to complete a transaction. Additionally, the verbal confirmation parameter may be defined such that only transactions occurring outside of the customer's authorized area require verbal confirmation.

Third-party user options 1504 allow the Message Wallet customer to authorize third-party users to process transactions through the customer's Message Wallet using the third-party's wireless phone. More particularly, a parent may use the third-party user options 1504 to allow a child to access the parent's Message Wallet to pay for the child's transactions.

The parent configures the Message Wallet to support third-party payments by entering the third-party's wireless phone. In the example of a parent supporting a child, the parent enters the wireless phone number of their child. Entering the child's wireless phone number links the child's Message Wallet account to the parent's Message Wallet account. When the child uses their personal cell phone to pay using the Message Wallet, the child's Message Wallet may then use the parent's Message Wallet to pay the retailer. Child-initiated transactions may require prior approval from the child's parent.

Response options 1505 allow the Message Wallet customer to choose whether to accept new changes and save the current configuration for future Message Wallet use. Alternatively, the customer may select the cancel option to cancel changes to the Message Wallet configuration.

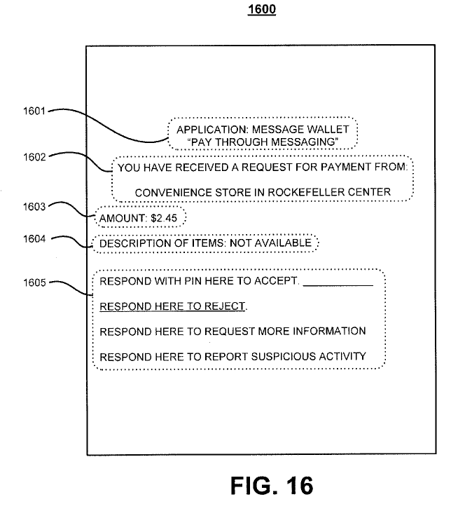

FIG. 16 is an illustration of an exemplary transaction authorization message interface 1600. A retailer sends the transaction authorization message 1600 to the customer's wireless phone after the customer initiates a purchase. A transaction authorization message 1600 includes several components: a title 1601, a retailer name 1602, a transaction total amount 1603, an item description 1604, and response options 1605.

The title 1601 is similar to titles 1201 and 1301, as described above.

The retailer name 1602 includes the name of the retailer requesting payment for a transaction. The retailer name 1602 notifies the Message Wallet customer of the retailer requesting the Message Wallet payment.

The transaction total amount 1603 includes the total purchase price for the items purchased from the retailer.

The item description 1604 includes a description of each item purchased. Alternatively, the item description 1604 may exclude a description of items, if the customer chooses to have the item description 1604 hidden. A Message Wallet customer may choose to have the item description hidden for a transaction authorization message 1600, as previously described for FIG. 14.

Response options 1605 allow the Message Wallet customer to choose whether to accept the transaction payment authorization request from the retailer. To accept, the transaction authorization message 1600 may require the Message Wallet user to enter a PIN. The PIN may be necessary to prevent authorized transactions. Alternatively, the customer may select the reject option to reject a Message Wallet payment to a retailer. Response option 1605 also may allow the customer to request more information about the transaction or report suspicious activity. For instance, if the Message Wallet customer receives a transaction request for items not purchased, the customer can request additional information regarding the transaction. Also, if the customer suspects that a third-party is attempting to fraudulently use the customer's Message Wallet, the suspicious activity may be reported.

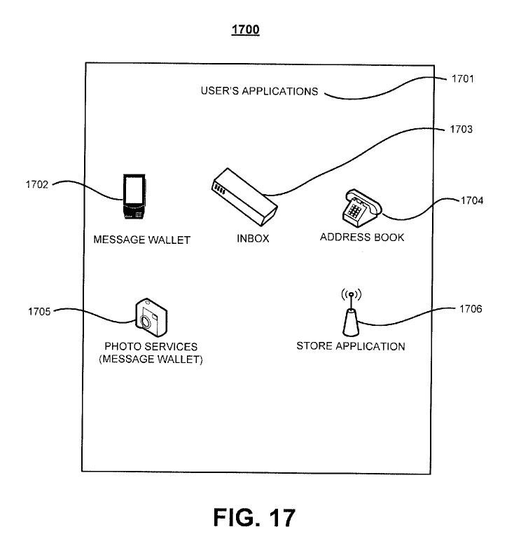

FIG. 17 is an illustration of an exemplary wireless phone menu 1700. The wireless phone menu allows a wireless phone user to access various wireless phone features and functionalities. The wireless phone menu 1700 includes several components: a title 1701, a Message Wallet icon 1702, an Inbox icon 1703, an Address Book icon 1704, a Photo Services icon 1705, and a Store Application icon 1706.

The title 1701 provides a descriptive name to alert the wireless phone user to the menu screen. For instance, the wireless phone menu 1700 may be entitled “User's Applications” to inform the user that the icons appearing on the menu 1700 allow access to wireless phone applications.

The Message Wallet icon 1702 provides access to the wireless phone user's Message Wallet. The user may select the icon to access the Message Wallet functionalities. For instance, the user may select the Message Wallet icon 1702 to access the Message Wallet to determine current account balance, review previous transactions, or set configuration options.

Inbox icon 1703 provides access to the wireless phone user's e-mail, text messages, and Message Wallet messages. The wireless phone user may select the Inbox icon to retrieve emails, text messages or Message Wallet messages. The inbox may allow the wireless phone user to integrate a plurality of e-mail and messaging addresses such that all messages may be retrieved, viewed, and sent through the wireless phone Inbox accessed through the Inbox icon 1703.

Address Book icon 1704 provides access to the wireless phone user's address book. A wireless phone user may store contact information by accessing the Address Book functions through the Address Book icon 1704. The Message Wallet functions may be integrated for use with the Address Book functions. For example, a Message Wallet user may access the Address Book through the Address Book icon 1704. The Message Wallet user may then select a plurality of contacts to which a payment is sent from the user's Message Wallet.

Photo Services icon 1705 allows the wireless phone user to access the wireless phone's Photo Services features. A wireless phone user may select the Photo Services icon to take, store, retrieve, edit, and delete pictures.

Store Application icon 1706 allows the wireless phone user to access the wireless phone's Store Application features. The Store Application feature may provide the wireless phone user with the ability to communicate with a store's POS system. For instance, a wireless phone user may select the Store Application icon 1706 and enter a shopping list. Once the shopping list is complete, the Store Application feature transmits the shopping list to a store and the shopping lists items are pulled from store shelves by store employees. Payment for the shopping list items may be authorized through the user's Message Wallet system. Later, the wireless phone user may arrive at the store to pick up the shopping list items which were earlier retrieved based on the transmitted shopping list. In another example, the Store Application feature may be used to preorder and purchase takeout food. The wireless phone user may transmit a takeout order to a retailer through the Store Application feature and pick up the food on the way home from work.

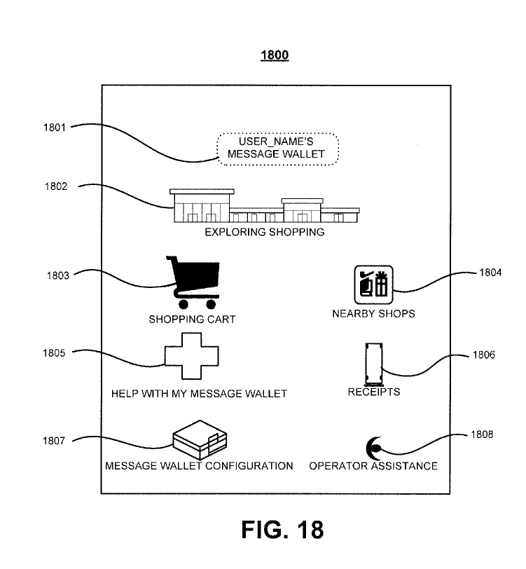

FIG. 18 is an illustration of an exemplary Message Wallet interface 1800. The Message Wallet interface 1800 includes several components: a title 1801, an Exploring Shopping icon 1802, a Shopping Cart icon 1803, a Nearby Shops icon 1804, a Help with My Message Wallet icon 1805, a Receipts icon 1806, a Message Wallet Configuration icon 1807, and an Operator Assistance icon 1807.

The title 1801 is a descriptive title that alerts the Message Wallet customer to the content of the display. The title may include the Message Wallet customer's username.

The Exploring Shopping icon 1802 provides a Message Wallet customer access to information regarding nearby stores. For example, the Message Wallet customer may access the Exploring Shopping icon 1802 to receive sale updates and special offers from nearby retailers. A retailer may sponsor a sale promotion and provide the Message Wallet customer with an electronic coupon to use with a future Message Wallet transaction. Additionally, the Message Wallet customer may access advertising materials transmitted by a retailer to the customer's Message Wallet.

The Shopping Cart icon 1803 allows a Message Wallet customer to access their electronic shopping cart to determine which items are ready for purchase. The shopping cart may provide a description of the items for purchase. Further, the electronic shopping cart may show the current price of each shopping cart item, the in-stock status of each item, and the total amount of the pending purchase. Further, the electronic shopping cart may show any applicable sales or coupons that may be added to the transaction. Any resulting discount may be reflected in the total amount of the pending purchase, as displayed to the Message Wallet user.

The Nearby Shops icon 1804 allows the Message Wallet customer to determine which retail shops are located nearby. When the Message Wallet customer selects the Nearby Shops icon 1804, the wireless phone determines the customer's location and displays a list of nearby retailers. Alternatively, the user may select the Nearby Shops icon 1804 and enter a specific store. The Nearby Shops interface then determines the location of the closest store. The Nearby Shops interface also may provide turn-by-turn directions to the customer's desired retail location.

The Help with My Message Wallet icon 1805 allows the Message Wallet customer to receive assistance in using the Message Wallet. For instance, when the Help with My Message Wallet icon 1805 is selected, the Message wallet customer may enter a question. The question is transmitted and an answer is returned to the Message Wallet customer. The answer may be returned in the form of link to a help file or a list of frequently asked questions. Alternatively, the Message Wallet customer may select the Help with My Message Wallet icon 1805 to access a live chat feature linking the Message Wallet customer to a live customer support representative. The Message Wallet customer and the customer support representative communicate via an electronic message chat system. In a different implementation, the Message Wallet user may select the Help with My Message Wallet icon 1805 to call a customer support representative. The Message Wallet customer may then use the wireless phone to communicate wirelessly with the customer support representative.

The Receipts icon 1806 allows the Message Wallet customer to access receipts for past transactions. Receipts may be stored locally, on the Message Wallet customer's wireless phone, or accessed through a wireless data connection to a Message Wallet Receipt Server that stores customer receipts from past transactions. The customer may access the Receipts icon 1806 to retrieve, view, and delete past receipts. Additionally, the user may search for past receipts based on certain parameters, such as retailer name, date, transaction number, transaction amount, and items purchased.

The Message Wallet Configuration icon 1807 allows a Message Wallet customer to select the icon and make changes to the Message Wallet configuration. For example, configuration options may include transaction thresholds and geographic limits, notification preferences, and authorized users. FIGS. 13-15 describe various configuration options in further detail.

The Operator Assistance icon 1807 allows the Message Wallet customer to contact an operator for assistance. The Message Wallet customer may select the Operator Assistance icon 1807 to contact an operator through an electronic chat. Alternatively, the Message Wallet customer may select the Operator Assistance icon 1807 to call the operator and receive assistance.

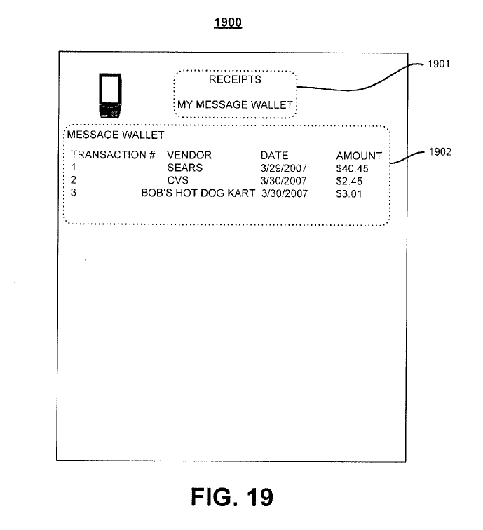

FIG. 19 is an illustration of an exemplary Receipts interface 1900. The Receipts interface displays stored receipts retrieved by the Message Wallet customer. The Receipts interface 1900 includes several components: a title 1901 and a receipt list 1902.

The title 1901 is a descriptive message that alerts the Message Wallet user to the displayed content.

The receipt list 1902 is a list of receipts from past Message Wallet transactions. Receipts may be stored on the wireless phone, or may be retrieved from a receipts server. A receipt server stores past purchase receipts. A Message Wallet customer may search for receipts based on date, transaction number, amount, retailer, and items purchased. After the search returns a result list, receipts may be listed by transaction number. Alternatively, receipts can be reordered. For instance, receipts may be listed in date order from most recent to oldest or oldest to most recent. Also, receipts may be ordered based on the transaction amount.

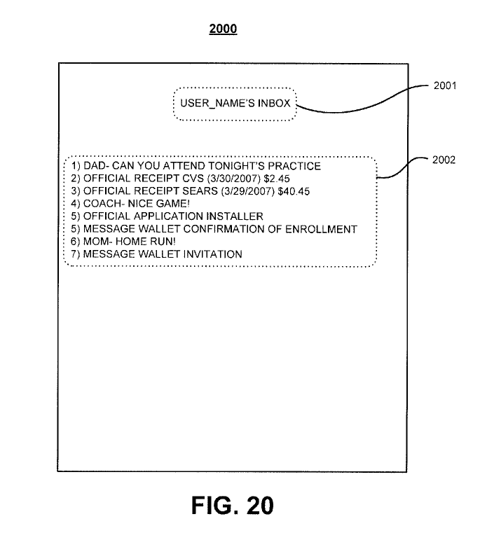

FIG. 20 is an illustration of an exemplary Inbox interface 2000. The Inbox interface allows user access to the wireless phone user's inbox. The Inbox interface includes several components: a title 2001 and a message list 2002.

The title 2001 is a descriptive message that alerts the Message Wallet user to the displayed content.

The message list 2002 includes a list of messages retrieved from all message sources. Messages are be listed by subject heading and may include additional information such as date and time the message is received and the sender's name and e-mail or other identifier. Further, the Inbox message list 2002 may be sorted by subject, date, time, sender, e-mail address, or source.

The wireless customer's Inbox provides an application to receive and view messages from multiple sources. Messages may be collected and aggregated from a plurality of message sources. For instance, the Inbox may retrieve and display messages from a Message Wallet customer's work email address. The Inbox also may be configured to receive and display SMS or other text messages sent to the Message Wallet customer's wireless phone. Additionally, Message Wallet messages, such as authorization messages, may be received in the customer's Inbox.

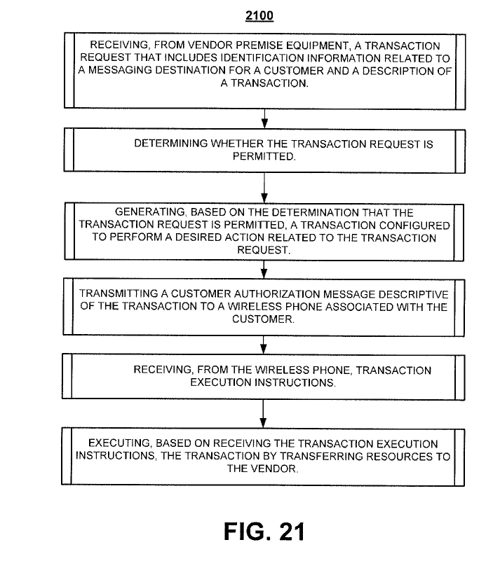

FIG. 21 is a flow chart of a process 2100 for handling transaction operations within the trusted intermediary system. Generally, the operations of process 2100 may be used in conjunction with the systems and configurations described earlier in FIGS. 1-10. For example, process 2100 may be performed during the credit card payment process 900 and the purchaser-to-seller payment and transaction process 1000. For convenience, a trusted intermediary system 903 is referenced as performing the process. However, similar methodologies may be applied in other implementations where different components are used to define the structure of the system, or where the functionality is distributed differently among the components shown.

A trusted intermediary system 903 receives, from vendor premise equipment, a transaction request that includes identification information related to a messaging destination for a customer and a description of a transaction. Next the trusted intermediary system 903 determines whether the transaction request is permitted. The trusted intermediary system 903 generates, based on the determination that the transaction request is permitted, a transaction configured to perform a desired action related to the transaction request. The trusted intermediary system 903 transmits a customer authorization message descriptive of the transaction to a wireless phone associated with the customer. Next, the trusted intermediary system 903 receives, from the wireless phone, transaction execution instructions. Then, the trusted intermediary system 903 executes, based on receiving the transaction execution instructions, the transaction by transferring resources to the vendor.

What is claimed is:

1. A method of enabling a consumer to pay a vendor, the method comprising:
enabling, using a vendor point of sale (POS) system, a consumer to enter a messaging address through which the user may receive communications on a wireless device;
enabling the consumer to identify goods for purchase from a vendor;
generating a transaction total for the identified goods;
receiving the messaging address from the consumer to pay the transaction total;
receiving, at an intermediary server operated by a wireless carrier, a transaction request for the consumer to pay the transaction total;
determining whether the transaction request is permitted;
transmitting, using the intermediary server, the transaction request to the wireless device associated with the messaging address;
presenting the transaction request to the consumer in a display on the wireless device;
enabling, using the wireless device, the consumer to authorize the transaction request;
receiving, using the wireless device, authorization for the transaction request;
transmitting the authorization to the intermediary server;
receiving, using the intermediary server; the authorization;
transferring, based on receiving the authorization, resources to the vendor to pay the transaction amount.

2. The method of claim 1 wherein enabling the consumer to enter the messaging address includes enabling the consumer to enter a phone number.

3. The method of claim 1 wherein enabling the consumer to enter the messaging address includes enabling the consumer to enter an email address.

4. The method of claim 1 wherein enabling the consumer to identify goods for purchase from the vendor includes enabling the consumer to present the goods to the vendor point-of-sale system used to execute transactions.

5. The method of claim 1 wherein receiving the messaging address from the consumer to pay the transaction total includes exchanging the messaging address using a short range wireless technology between a wireless phone and the vendor POS system.

6. The method of claim 1 wherein receiving, at the intermediary server operated by the wireless carrier, the transaction request for the consumer to pay the transaction total includes identifying a message as a payment request and routing the message through a payment processor.

7. The method of claim 1 wherein identifying the message as the payment request and routing the message through the payment processor includes routing the payment request through a financial institution system for processing.

8. The method of claim 1 wherein identifying the message as the payment request and routing the message through the payment processor includes routing the payment request through an internal transfer-of-funds system for processing.

9. The method of claim 1 wherein determining whether the transaction request is permitted includes determining whether an existing balance includes sufficient resources.

10. The method of claim 1 further comprising enabling the consumer to identify one of several accounts against which the transaction is executed.

11. The method of claim 1 wherein transmitting, using the intermediary server, the transaction request to the wireless device associated with the messaging address includes transmitting the transaction request as a SMS message.

12. The method of claim 1 wherein transmitting, using the intermediary server, the transaction request to the wireless device associated with the messaging address includes transmitting the transaction request as a MMS message.

13. The method of claim 1 wherein presenting the transaction request to the consumer in a display on the wireless device includes configuring the transaction request to be presented in an electronic wallet application.

14. The method of claim 1 wherein presenting the transaction request to the consumer in a display on the wireless device includes configuring the transaction request to be presented in a messaging inbox.

15. The method of claim 1 wherein enabling, using the wireless device, the consumer to authorize the transaction request includes enabling a consumer to respond to the transaction request with an instruction on how to process the transaction request.

16. The method of claim 1 wherein enabling, using the wireless device, the consumer to authorize the transaction request includes enabling a consumer to respond to the transaction request with an authorization code to process the transaction request.

17. A system configured to process messages, the system comprising:
means for receiving, from a first user on a wireless phone, a first message addressed to a second user;
means for accessing an extended header for the first message related to the first user;
means for generating, based on accessing the extended header, an alert configured to prompt the second user for processing instructions for the first message;
means for receiving a response to the alert from the second user;
means for generating, if the response includes an instruction from the second user to validate the message, a validation request;
means for processing, using a certificate authority, the validation request;
means for generating, based on a validation decision by the certificate authority for the validation request, a report for the second user with one or more processing options;
means for receiving, from the second user, an instruction with a selection from among processing options; and
means for delivering the first message to the second user if the instruction from the second user indicates that the message should be delivered.

18. A computer program on a computer readable medium, the computer program comprising instructions that when executed on a processor cause the processor to:
receive, from a first user on a wireless phone, a first message addressed to a second user;
access an extended header for the first message related to the first user;
generate, based on accessing the extended header, an alert configured to prompt the second user for processing instructions for the first message;
receive a response to the alert from the second user;
generate, if the response includes an instruction from the second user to validate the message, a validation request;
process, using a certificate authority, the validation request;
generate, based on a validation decision by the certificate authority for the validation request, a report for the second user with one or more processing options;
receive, from the second user, an instruction with a selection from among processing options; and
deliver the first message to the second user if the instruction from the second user indicates that the message should be delivered.

19. A method of executing a transaction, the method comprising:
receiving, from vendor premise equipment, a transaction request that includes identification information related to a messaging destination for a customer and a description of a transaction;
determining whether the transaction request is permitted;
generating, based on the determination that the transaction request is permitted, a transaction configured to perform a desired action related to the transaction request;
transmitting a customer authorization message descriptive of the transaction to a wireless phone associated with the customer;
receiving, from the wireless phone, transaction execution instructions; and
executing, based on receiving the transaction execution instructions, the transaction by transferring resources to the vendor.

20. A system configured to execute a transaction, the system comprising:
means for receiving, from vendor premise equipment, a transaction request that includes identification information related to a messaging destination for a customer and a description of a transaction;
means for determining whether the transaction request is permitted;
means for generating, based on the determination that the transaction request is permitted, a transaction configured to perform a desired action related to the transaction request;
means for transmitting a customer authorization message descriptive of the transaction to a wireless phone associated with the customer;
means for receiving, from the wireless phone, transaction execution instructions; and
means for executing, based on receiving the transaction execution instructions, the transaction by transferring resources to the vendor.

21. A computer program on a computer readable medium, the computer program comprising instructions that when executed on a processor cause the processor to:
receive, from vendor premise equipment, a transaction request that includes identification information related to a messaging destination for a customer and a description of a transaction;
determine whether the transaction request is permitted;
generate, based on the determination that the transaction request is permitted, a transaction configured to perform a desired action related to the transaction request;
transmit a customer authorization message descriptive of the transaction to a wireless phone associated with the customer;
receive, from the wireless phone, transaction execution instructions; and
execute, based on receiving the transaction execution instructions, the transaction by transferring resources to the vendor.
